(19) United States
(12) Patent Application Publication
(10) Pub. No.: US 2014/0207718 A1
(43) Pub. Date: Jul. 24, 2014

(54) METHOD AND APPARATUS FOR IDENTIFYING USERS FROM RATING PATTERNS

(71) Applicant: THOMSON LICENSING, Issy de Moulineaux (FR)

(72) Inventors: Jose Bento Ayres Pereira, Cambridge, MA (US); Nadia Fawaz, Santa Clara, CA (US); Andrea Montanari, Sunnyvale, CA (US); Stratis Ioannidis, San Francisco, CA (US)

(73) Assignee: THOMSON LICENSING, Issy de Moulineaux (FR)

(21) Appl. No.: 14/237,903

(22) PCT Filed: Aug. 10, 2012
(86) PCT No.: PCT/US2012/050246

§ 371 Date: Feb. 10, 2014

Related U.S. Application Data
(60) Provisional application No. 61/523,093, filed on Aug. 12, 2011.

(51) Int. Cl. G06N 7/00; G06N 99/00

(52) U.S. Cl. CPC G06N 7/005; G06N 99/005
USPC 706/12; 706/52

(57) ABSTRACT

Disclosed are methods and apparatus for identifying users of content. The methods include identifying contextual information of a group of users, gathering user access data of the users on the basis of the contextual information of the group of users, analyzing temporal information of the user access data, and identifying particular users in the group of users on the basis of the analyzed temporal information and the contextual information.

### RELATED APPLICATION

This application claims the benefit under 35 U.S.C. §119(e) of U.S. Provisional Application Ser. No. 61/523,093 filed on Aug. 12, 2011 and entitled “Identifying Users From Their Rating Patterns”, the teachings of which are specifically incorporated herein by reference as if explicitly set forth herein.

### FIELD OF THE INVENTION

This invention relates generally to the field of context aware movie recommendations. More specifically, this invention relates to the use of temporal information to identify users within a boundary with greater accuracy.

### BACKGROUND OF THE INVENTION

As more video and audio content proliferates, both through the Internet and private services, it is increasingly important for providers of this content to develop accurate and efficient modalities for identifying users of the content, and the user's access and viewing patterns of the content. Many, if not most, prior ways of obtaining this information relied on actual user preference ratings wherein users directly rate the content based on specific and directed requests to do so, or at least in conjunction with their view, access or obtaining of the content. However, this kind of data and the information gleaned from it is often inaccurate or misleading, and therefore does not provide accurate or useful results for the content provider or distributor. Such systems which use this type of approach (sometimes denoted as “recommendation systems”) are not effective to gather useful information.

The incorporation of contextual information is likely to play an ever-increasing role in recommendation systems because of the broad availability of such information, and the need for more accurate systems. Among sources of contextual information, the social structure of a given pool of users is particularly interesting in view of the potential convergence between online social networks and recommendation systems. The use of social structures, for example a household of people, usually a family, has not been exploited in the past by recommendation systems. Thus, there has not heretofore been developed a recommendation which can exploit such information to identify users within a household in order to provide content providers or distributors of content a good basis for understanding how to target content to such users.

It would be useful o develop a recommendation system based at least on the use of temporal information of user access in an environment, for example a household, to provide information for targeted offerings. Such temporal information would be particularly beneficial if it included also user ratings such that the temporal information included timing information, for example a time stamp, of when the rating was performed by the user. Such results have not heretofore been achieved in the art.

### SUMMARY OF THE INVENTION

The aforementioned problems are solved, and long-felt needs met by methods of identifying users of content, and apparatus therefore, provided in accordance with the present invention. In preferred embodiments, the methods comprise identifying contextual information of a group of users, gathering user access data of the users on the basis of the contextual information of the group of users; analyzing temporal information of the user access data; and identifying particular users in the group of users on the basis of the analyzed temporal information and the contextual information.

In further preferred embodiments, methods of identifying users of content, and apparatus therefore, provided in accordance with the invention are provided wherein the methods comprise observing temporal patterns of viewing of a group of users over a time frame; quantifying the observations of the temporal pattern to obtain an empirical probability distribution of rating events associated with the users over different sub-time frames within the time frame; and predicting each user's content use behavior based on the quantified temporal observations to obtain a predicted use profile for the users.

Even more preferably, methods of identifying users of content, and apparatus therefore, provided in accordance with the present invention are provided wherein the methods comprise classifying a set of user ratings of content by approximating a matrix of ratings by a low rank matrix; minimizing regularized empirical loss of the matrix of ratings; iteratively updating the matrix of ratings and updating the matrix after empirical losses are minimized; and identifying users based the iteratively updated matrix.

The invention will be better understood by reading the Detailed Description of the Preferred Embodiments, in conjunction with the Drawings which are first described briefly below.

### BRIEF DESCRIPTION OF THE DRAWINGS

FIG. 1 shows the average misclassification rate vs. number of iterations K, for different values of parameters.

FIG. 2 show the TPR of user 1 in each household vs. TPR of any other user.

FIG. 3 show histograms of rating events across days of the week (day 1 is Sunday) for four households, wherein the first three households have two members, while the fourth has three and for each day of the week, |H| histograms are shown, each indicating the number of viewing events of a household member.

FIG. 4 shows a histogram of the average total variation distance δ_{H} across the 290 households in the training dataset wherein the majority of households have an average total variation close to 1, indicating that the distributions of rating events by different household members have almost disjoint supports.

FIG. 5 depicts a PDF of the residual error across (a) all ratings in the training dataset and (b) all ratings given by a single user wherein the distributions are well approximated by normals.

FIG. 6 is a flow diagram of a method for identifying users of content in accordance with the present invention.

FIG. 7 is a flow diagram of a method for identifying users of content using temporal patterns in accordance with the present invention.

FIG. 8 is a flow diagram of a method for identifying users of content using minimized, low rank rating matrices in accordance with the present invention.

### DETAILED DESCRIPTION OF THE PREFERRED EMBODIMENTS

Referring now to the drawings wherein like reference numerals refer to like elements,

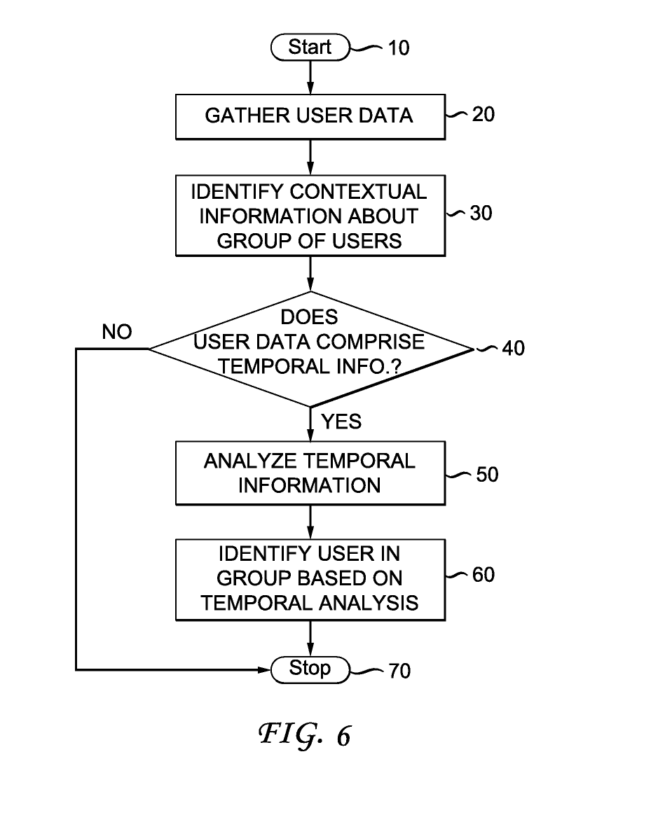

FIG. 6 depicts a preferred method of identifying users of content which starts at step 10. This method preferably utilizes a low-rank approximation that provides an effective tool to embed the collection of movies and users at hand, within a low-dimensional latent space [symbol] ^{r}, r<<m, n. A high rating provided by user i on movie j corresponds to latent space vectors with large inner product. Latent vectors associated with users within the same household are utilized to infer which user rated a certain movie, by selecting the latent vector whose inner product with the movie vector best reproduces the observed rating. Generalizing, these models may be extended to include temporal variability, in both users' and movies' latent vectors. If our temporal units are the 12 months of the year, the resulting model achieves an overall misclassification rate P≈0.3735.

At step 20 user data corresponding to a user or many users content access is gathered. At step 30, contextual information about the group of users is identified. It will be appreciated that the contextual information may be information about the users' household, as well as the particular social networks that the users engage in, or belong to. Other contextual may also be gathered for, example, but not limited to, the users' club memberships, age groups, ethnic groups, religious groups, social groups, and others. All such information is typically used solely for the purpose of provided content creators or distributors with information so as to provide targeted content to the users to give the users the best experience possible with their viewing choices.

At step 40 it is determined whether the user data comprises temporal information. The temporal information is usually the time in a time frame, or a sub-time frame in which the time frame is broken into, at which the user accesses particular content. With temporal information in conjunction with the contextual information a more efficient ratings analysis can be performed in accordance with the invention to give the content provider or distributor more accurate view and rating habit of the users. The temporal information could be a daily, weekly, hourly or time frame gradation in which a user accesses content. It may also be a range of times at which a user is accessing a website or service from which content may be viewed. In a preferred embodiment, the temporal information is a time stamp of a point in time that a user either views or accesses content, or the time point at which a user actually rates the content. All such time instances are intended to be used in accordance with the inventive methods.

If at step 40 the user data does not comprise temporal information then the data may be analyzed in relation to user preferences or actual ratings, in which case the method stops a step 70. If however it is determined that temporal information exists, then at step 50 the temporal information is analyzed. At step 60 the users in the group are identified based on the temporal analysis performed, thereby giving content providers and distributors a salient and effective tool to optimize the users' experience with their content. The method then stops at step 70.

Many types and forms of datasets are usable in the inventive methods. A preferred dataset which was used to test and generate meaningful results is the CAMRa 2011 dataset (Track 2) as described below. This dataset produced the following results as shown in Table 1:

TABLE 1
Best misclassification rates obtained for the challenge data
set (Track 2). We report the average misclassification rate over
all households, average over all households of size 2, of
size 3 and of size 4 respectively.

| | Any size | Size 2 | Size 3 | Size 4 |
|---|---|---|---|---|
| Misclassification rate | 0.0406 | 0.0413 | 0.0268 | 0.0463 |

The training data consists of a collection of 4536891 ratings. Each entry (rating) takes the form:

(i,j,Mᵢⱼ, tᵢⱼ). (1)

Here i∈[m] (with m=171670) is a user ID, j∈[n] (with n=23974) is a movie ID, Mij (with 0≦Mij≦100) is the rating provided by user i on movie j, and tij is the time-stamp of that rating. ([N]={1, . . . ,N} denotes the set of first N integers.) We denote by E ⊂ [m]×[n] the subset of user-movie pairs for which a rating is available.

The training data also includes information about the household structure of a subset of users.

This provided in the form of 290 household-composition tuples:

(H, i₁, . . . , iₖ). (2)

Here H is a household ID, and i1, . . . , iL are the IDs of users belonging to household H. The number L of users in the same household varies between 2 and 4. We will write i∈H to indicate that user i belongs to household H. For instance, given the above tuple, we know that i1, . . . , iL∈H.

The test data comprises 5450 tuples of the form:

(H, j, M_{Hj}, t_{Hj}), (3)

whereby H is a household ID, j is a movie ID, MHj is a rating provided by one of the users in H for movie j, and tHj is the corresponding time-stamp. The challenge Track 2 requires to infer the user i∈H that actually provided these ratings.

In the following, we denote by “Train” the train set, and by “Test” the test set.

The use of low rank matrix approximations in accordance with the invention can be characterized in three pieces. Generally, they are rating prediction from a training set, rating classification in a test set, and evaluation of the misclassification rate on the challenge data set. Two collaborative filtering methods, based on low-rank matrix completion, to predict the missing ratings in a training set is a first approximation. The first method relies only on the ratings provided in the training set to predict the missing ratings. The second method also factors in the context by taking into account the temporal information in the training set. Then turning attention to the test set, it contains household ratings, and uses the aforementioned prediction models to identify which user in a household provided a given rating in the test set. Empirical results are derived based on the preferred dataset in terms of misclassification rate and ROC curve.

Throughout this section, it is denoted by x˜U[a,b] a random variable x uniformly distributed in [a,b]. For x,y∈ [symbol] , [symbol] x,y [symbol] =x^{T}y=Σₗ₌₁ⁿx ₗyₗ denotes the usual inner product, and ∥x∥²= [symbol] x,x [symbol] For M∈ [symbol] ^{m×n}, ∥M∥_{F} is its Froebenius norm. We let 1ₙ=[1, . . . , 1]^{T}, and Iₙ be the identity matrix of size n.

### Simple Low-Rank Approximation

### Model

A simple low rank model is obtained by approximating the matrix of ratings M∈ [symbol] ^{m×n} by a low-rank matrix \hat{M}=UV^{T}+Z1ₙ^{T} , where matrix U=[u₁| . . . |uₘ]^{T} is of size m×r, matrix V=[v₁| . . . |vₙ]^{T} is of size n×r, and the column vector Z=[z₁, . . . ,zₘ]^{T} is of length m. Each vector uᵢ∈ [symbol] ^{r} is associated with a user i∈[m], and each vector vⱼ∈ [symbol] ^{r} corresponds to a movie j∈[n]. The column vector Z models the rating bias of each user. Matrices U, V and Z are found by minimizing the following regularized empirical l₂ loss

$$C ( U , V , Z ) ≡ \frac{1}{2} {\sum }_{( i , j ) ∈ E} {( {M}_{ij} - 〈 {u}_{i} , {v}_{j} 〉 - {z}_{i} )}^{2} + \frac{λ}{2} {‖ U ‖}_{F}^{2} + \frac{λ}{2} {‖ V ‖}_{F}^{2} . \qquad ( 6 )$$

### Alternate Minimization

Algorithm 1 Low rank approximation

```
procedure Initialization
  $∀ ( i , j ) ∈ [ m ] \times [ r ] , {u}_{ij}^{( 0 )} \sim \frac{U [ 0 , 1 ]}{\sqrt{m}}$
  $∀ ( i , j ) ∈ [ r ] \times [ n ] , {v}_{ij}^{( 0 )} \sim \frac{U [ 0 , 1 ]}{\sqrt{n}}$
  ∀i ∈ [m], zᵢ⁽⁰⁾ = 50
procedure Iterations(K)
  for k = 1 . . . K do
    for i = 1 . . . m do
      uᵢ^{(k)} = g(V_{E}_{ᵢ}^{(k-1)}, M_{iE}_{ᵢ}^{T} − 1_{|E}_{ᵢ}_{|}zᵢ^{(k-1)}, λ)
    for j = 1 . . . n do
      vⱼ^{(k)} = g(U_{F}_{ⱼ}^{(k)}^{^{T}}, M_{F}_{ⱼ}ⱼ − z_{F}_{ⱼ}^{(k-1)}, λ)
    for i = 1 . . . m do
      zᵢ^{(k)} = g(1_{|Ei|}^{T}, M_{iE}_{ᵢ}^{T} − V_{E}_{ᵢ}^{(k)}^{^{T}}uᵢ^{(k)}, 0)
Return (U^{(K)}, V^{(K)}, Z^{(K)})
```

The cost function is non convex, but several iterative minimization methods have been developed with excellent performances in practical settings. Performances guarantees for algorithms of this family were proved in, under suitable assumptions on the matrix M. Alternative approaches based on convex relaxations have been studied in.

In a preferred embodiment, a simple alternate minimization algorithm is adopted for very similar algorithms. Each iteration of the algorithm consists of three steps: in the first step, V and Z are fixed, and U is updated by minimizing; then U and Z are fixed, and V is updated; finally, U and V are fixed and Z updated. A pseudocode for the algorithm is presented in Algorithm. The algorithm stops after K iterations, and returns the triplet (U,V,Z).

Since the cost is separately quadratic in each of U, V and Z, each of the steps can be performed by matrix inversion. In fact, the problem presents a convenient separable structure. For instance, the problem of minimizing over U is separable in u₁, u₂, . . . , uₘ. Minimizing C (U, V, Z) over a vector uᵢ is equivalent to a Ridge regression in u whose exact solution is given by

uᵢ=(V_{Ei}V_{Ei}^{T}+λIᵣ)⁻¹V_{Ei}(M_{iE}_{ᵢ}−zᵢ1_{|E}_{ᵢ}_{|}^{T})^{T}, (7)

where Eᵢ={j∈[n]|(i,j)∈E}, M_{iEi}=[mᵢⱼ]_{j∈Ei}∈ [symbol] ᵢ^{x|E|}, and V_{Ei}=[vⱼ]_{j∈Ei}∈ [symbol] ᵢ^{r×|E|}. In order to concisely represent this basic update, we define the function g as follows. Given a matrix A∈ [symbol] ^{r×n}, a column vector x∈ [symbol] ⁿ, and a real number α, β∈ [symbol] , we let g(A,x,α)=(AA^{T}+αIᵣ)⁻¹ Ax. The above update then reads u=g(V_{Ei}, M_{iEi}^{T}−1_{|Ei|}zᵢ, λ). Define Fⱼ={i∈[n]|(i j)∈E}. Proceeding analogously for the minimization over V and Z, it is possible to obtain Algorithm 1 .

### Low Rank Approximation With Time-Dependent Factors

It is also possible to extend the previous low-rank prediction model to account for temporal information. The following Model is preferably employed to do so.

### Model

In this model, we bin time into T bins of equal duration, indexed by b∈{1, . . . T}. Given that user i rates movie j at time tᵢⱼ, and denoting by b(tᵢⱼ)∈[T] the unique bin index for the observed rating of the pair (i,j).

Let M∈ [symbol] ^{m×n×T} be the three-dimensional rating tensor whose entry Mᵢⱼ(b) represents the rating that user i∈[m] would give to movie j∈[n] at a time in bin b∈[T]. The matrix M(b)∈ [symbol] ^{m×n} represents the rating matrix in bin b. From a training set of observed ratings {Mᵢⱼ(b)|(i,j)∈E}, we predict the missing ratings by approximating each matrix M(b), b∈[T] by a low rank matrix , \hat{M}(b)=U(b)V (b)^{T}+Z(b)1ₙ^{T}. This is a natural extension of the previously described model. Matrices U(b)∈^{m×r}, V(b)∈ [symbol] ^{n×r} and Z(b)∈^{m×1} are stacked in the tensors U∈^{m×r×T}, V∈ [symbol] ^{r×n×T} and Z∈ [symbol] ^{m×1×T} respectively. It is possible to obtain the tensors (U,V,Z) by minimizing the following regularized l₂ loss

$$C ( U , V , Z ) ≡ {R}_{λ , {ξ}_{u}} ( U ) + {R}_{λ , {ξ}_{v}} ( V ) + {R}_{0 , {ξ}_{z}} ( Z ) + \frac{1}{2} {\sum }_{( i , j ) ∈ E} {( {M}_{ij} ( b ( {t}_{ij} ) ) - 〈 {u}_{i} ( b ( {t}_{ij} ) ) , {v}_{j} ( b ( {t}_{ij} ) ) 〉 - {z}_{i} ( b ( {t}_{ij} ) ) )}^{2} , \qquad ( 8 )$$

where the regularization terms are of the form

$${R}_{λ , ξ} ( U ) = \frac{λ}{2} {\sum }_{b = 1}^{T} {‖ U ( b ) ‖}_{F}^{2} + \frac{ξ}{2} {\sum }_{b = 1}^{T - 1} {‖ U ( b + 1 ) - U ( b ) ‖}_{F}^{2} . \qquad ( 9 )$$

Each regularization function consists of two terms: the first term is an t, regularization for shrinkage, while the second term promotes smooth time-variation. Note that by setting the number of bins to T=1, this model reduces to the previously described, time-independent model The same happens by letting ξᵤ, ξᵥ, ξ_{z}→∞.

### Alternate Minimization

Algorithm 2 Time-dependent low rank approximation

```
procedure Initialization
  $∀ ( i , j , b ) ∈ [ m ] \times [ r ] \times [ T ] , {{u}_{ij} ( b )}^{( 0 )} \sim \frac{U [ 0 , 1 ]}{\sqrt{m}}$
  $∀ ( i , j , b ) ∈ [ r ] \times [ n ] \times [ T ] , {{u}_{ij} ( b )}^{( 0 )} \sim \frac{U [ 0 , 1 ]}{\sqrt{n}}$
  ∀(i, b) ∈ [m] × [T], zᵢ(b(t))⁽⁰⁾ = 50
procedure Iterations(K, T)
  for k = 1 . . . K do
    for b = 1 . . . T do
      for i = 1 . . . m do
        uᵢ(b)^{(k)} = h(V_{E}_{ᵢ}_{(b)}^{(k-1)}, M_{iE}_{ᵢ}_{(b)}^{T} − 1_{|E}_{ᵢ}_{(b)|}zᵢ(b)^{(k-1)}, uᵢ(b + 1)^{(k-1)} + uᵢ(b − 1)^{(k)}, λ + 2ξᵤ, ξᵤ)
      for j = 1 . . . n do
        vⱼ(b)^{(k)} = h(U_{F}_{ⱼ}_{(b)}^{(k)}^{^{T}}, M_{F}_{ⱼ}_{(b)j} − z_{Fj}(b)^{(k)}, vⱼ(b + 1)^{(k-1)} + vⱼ(b − 1)^{(k)}, λ + 2ξᵥ, ξᵥ)
      for i = 1 . . . m do
        zᵢ(b)^{(k)} = h(1_{|E}_{ᵢ}_{(b)|}^{T}, M_{iE}_{ᵢ}_{(b)}^{T} − V_{E}_{ᵢ}_{b}^{(k)}^{^{T}} uᵢ(b)^{(k)}, zᵢ(b + 1)^{(k-1)} + zᵢ(b − 1)^{(k)}, 2ξ_{z}, ξ_{z})
Return (U^{(K)}, V^{(K)}, Z^{(K)})
```

In order to minimize the cost function, it is possible to generalize the immediately preceding alternate minimization algorithm. This is done by cycling over the time bin index b and, for each b, we sequentially minimize over U(b), V (b) and Z(b), while keeping U(b′), V (b′) and Z(b′), b′≠b fixed. As before, each of these three minimization problems is quadratic and hence solvable efficiently. Further, each of these quadratic problems is separable across user indices (for minimization over U and Z) or movie indices (for minimization over V). On the other hand, it is not separable across time bins because of the second term in the regularization function, cf. Eq. 9. As a consequence, the update steps change somewhat.

Consider—to be definite—the minimization over U. A straightforward calculation yields the following expression for the minimum over uᵢ(b), when all other variables are kept constant

uᵢ(b)=(V_{Ei(b)}V_{Ei(b)}^{T}+(λ+ξᵤ)Iᵣ)⁻¹×(V_{Ei(b)}(M_{iE}_{ᵢ}_{(b)}−zᵢ(b)1_{|E}_{ᵢ}_{(b)|}^{T})^{T}+ξᵤ(uᵢ(b+1)+uᵢ(b−1)))

where it was assumed that b∈{2, . . . , T−1} (the boundary cases b=1, T yield slightly different expressions). Defining h(A,x,y,α,β)=(AA^{T}+αIᵣ)⁻¹(Ax+βy), the above can be written as u,(b)=h(V_{Ei(b)}, M_{iEi(b)}^{t}−1_{|Ei(b)|}zᵢ(b),uᵢ(b+1)+uᵢ(b−1),λ+2,ξᵤ, ξᵤ).

Analogous expressions hold for minimization over z,(b) and v,(b). A complete pseudocode is provided in Algorithm 2.

### Household Rating Classification and Results

For each entry in the test set, the goal is to identify which user in the household provided the rating. In this section, our approach uses the rating and the corresponding time-stamp provided within the test set, and the low rank model obtained from the training set. Given a rating M_{Hj} within household H={iᵢ, . . . i_{L}}, the simplest idea is to attribute the rating to the user i∈H for which the predicted rating is closest to M_{Hj}. In other words, we return arg min_{i∈H}|M_{Hj}−\hat{M}ᵢⱼ((b(t_{Hj}))|.

In order to explore the tradeoff between precision and accuracy through an ROC curve, a slight generalization of this rule is accomplished by introducing a parameter α≧0, as follows.

1. First, for each user i∈H, we compute the difference: |M_{Hj}−\hat{M}ᵢⱼ(b(t_{Hj}))|.
2. Consider the first user i₁∈H. If

$$α \vert {M}_{{H}_{j}} - {\hat{M}}_{{i}_{1} j} ( b ( {t}_{Hj} ) ) \vert < {min}_{i ∈ H \backslash {i}_{1}} \vert {M}_{Hj} - {\hat{M}}_{ij} ( b ( {t}_{Hj} ) ) \vert ,$$

and therefore conclude that user i₁ provided the household rating M_{Hj}. Otherwise, conclude it was some other user in the household.

### Parameter Selection and Results

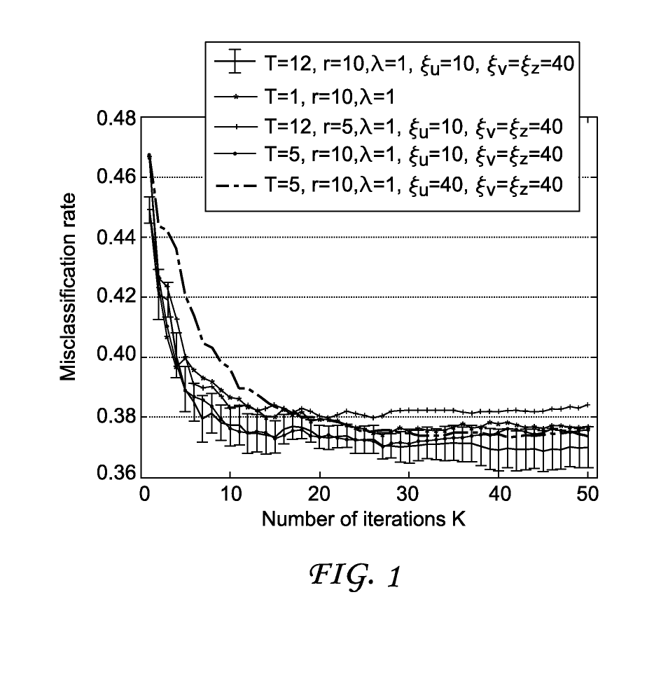

It has been found that time-dependent factorization leads to more accurate predictions, and it subsumes the time-independent approach as a special case. The accuracy of these predictions has been determined through cross-validation for several choices of the regularization parameters. FIG. 1 shows the average misclassification rate versus the number of iterations for various values of parameters. The misclassification rate is close to 37%, and seems to become stable after about 50 iterations. We thus fixed K=50, and selected the following values of parameters by minimizing the misclassification rate: number of bins T=12; rank r=10; regularization parameters λ=1, ξᵤ=10, ξᵥ=ξ_{z}=40 .

The results in FIG. 1 were obtained by random-subsampling cross validation. An average over 5 different splits of the dataset into training set and test set was performed. In each split, the test set was selected by randomly hiding approximately 4% of the data of each household. The curves obtained with the original training and test sets provided in the dataset are close to the ones in FIG. 1. This cross validation procedure is more reliable from a statistical point of view.

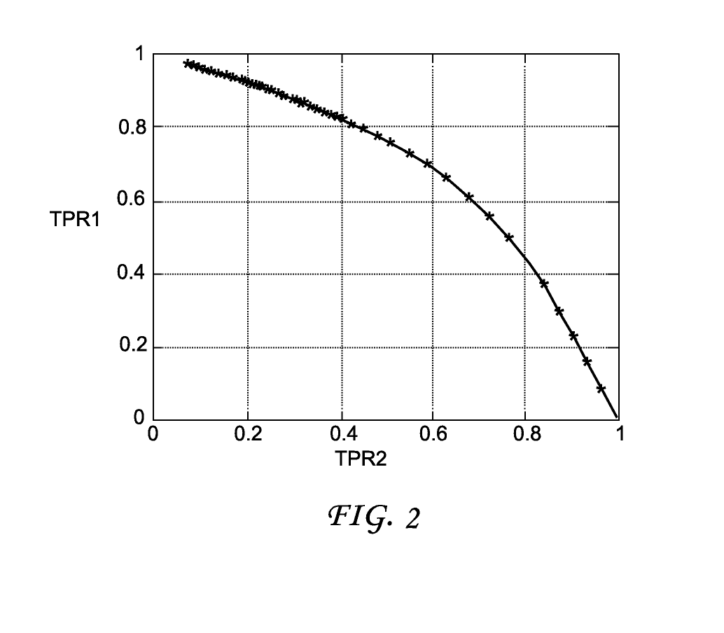

FIG. 2 shows the ROC curve achieved by the present classification method, for varying α. Each point of the curve corresponds to the average of the pair (TPR1 (α), TPR2(α)) over all households in a (Train, Test) pair, itself averaged over all (Train, Test) pairs (splits). Bars show the standard deviation from the mean over different (Train, Test) splits.

Many different types of temporal analysis may be performed in accordance with the invention to achieve user profiles and use characteristics. For example, temporal patterns over a time frame or sub-time frame may be employed to achieve these results. Alternately, empirical loss analysis may be employed wherein a matrix of low rank may be constructed having low losses associated therewith, whereby the losses are minimized by iterative techniques. Another possible alternative is the use of a unified approach wherein a unified framework based on binary classification for example is implemented to exploit latent space information as well as temporal information, along with the contextual information. All such embodiments are within the scope of the present invention.

It will also be appreciated by those with skill in the art that the present methods may be implemented in software, firmware or hardware as is convenient. For example, a digital signal processor (DSP) may be implemented to provide continuous, real-time analysis of user access for continuous feedback. The methods may be practiced on general or special purpose processors which are integrated with the proper software to implement the techniques described herein. The data gleaned from these processes may be provided on a real-time basis to content providers or distributors, or may undergo further data reduction techniques before provision. All such embodiments are intended to be covered by the invention.

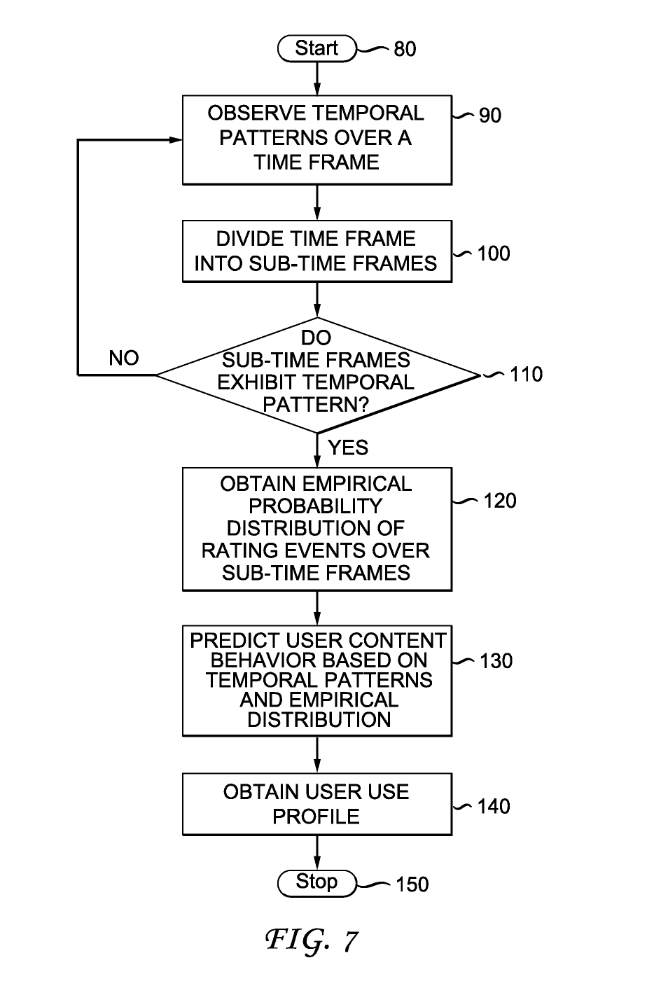

In yet a further preferred embodiment of the invention, FIG. 7 depicts a flow chart wherein a method starts at step 80. This second embodiment makes a crucial use of temporal patterns in the users rating behavior. Interestingly an important advantage in this approach is that different users within the same household exhibit very well separated viewing habits.

These habits are clearly demonstrated by comparing the distribution of ratings across the days of the week for two users in the same household. For a large number of households, these distributions have almost disjoint support. A simple algorithm that uniquely uses the day of the week to infer the user identity, achieves a misclassification rate P≈0.1154. A generative model may also be utilized which incorporates both ratings (through low-rank approximation) and temporal patterns, achieving P≈0.0950.

Although the matrix factorization model captures the evolution of user and movie profiles throughout the 12-month period of the dataset, it does not make direct use of the rating time-stamp in order to classify ratings within a household. The time-stamp is only used indirectly, namely to compute the predicted ratings \hat{M}ᵢⱼ.

On the other hand, temporal behavior—especially weekly behavior—appears to be extremely useful in distinguishing users within the same household. Household members exhibit distinct temporal patterns in their viewing habits. Rather than viewing movies together, in many households users consistently rate movies at different days of the week.

As a result, the day of the week on which a movie is rated provides a surprisingly good predictor of the user who watched it. In light of these observations, generative model that incorporates the day of the week as well as the movie rating is provided in a preferred embodiment.

### Temporal Patterns in User Behavior

Clear temporal patterns emerge when considering the day of the week on which ratings are given. Most importantly, the temporal patterns in the viewing behavior of members of the same household turn out to be very well separated.

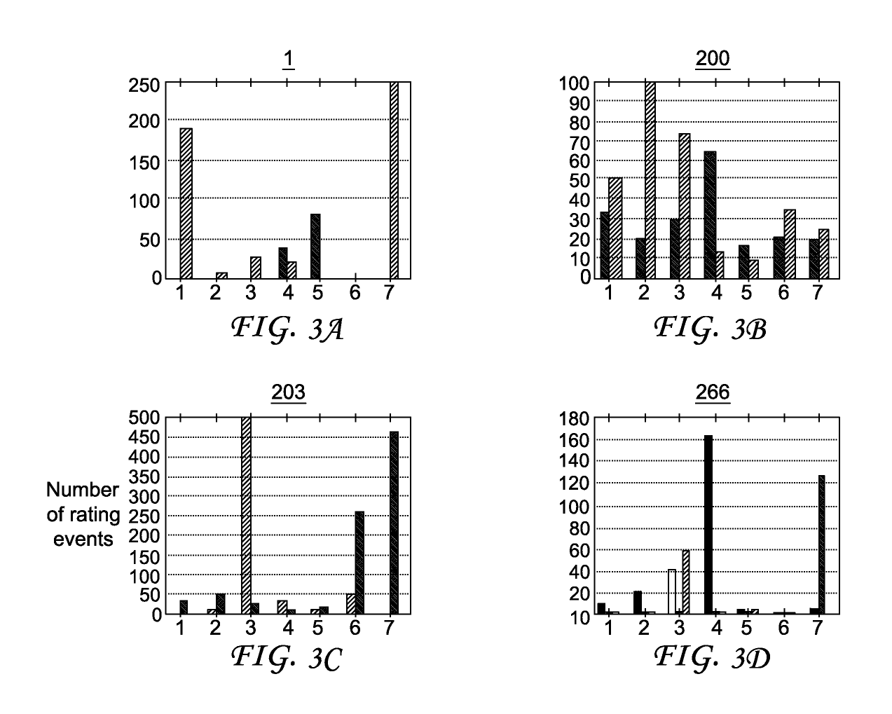

As an illustration, FIG. 3 shows the frequencies with which users view movies on different days of the week for four households (labeled 1, 200, 203, and 266 in the training set). It can be seen that, in households 1, 203, and 266, household members tend to view and rate movies at very distinct days of the week. For example, in household 1, one user watches movies mostly on Sunday and Saturday, while the other watches movies in the middle of the week.

This phenomenon is repeated in most of the households in the training set. In order to quantify this observation, let pᵢ(d) denote the empirical probability distribution of rating events associated with user i∈[m] over different days d∈W={Sun, Mon, . . . , Sat} (normalized so that Σ_{d∈}Wpᵢ(d)=1). Average total variation of a household H as

$${δ}_{H} = \frac{1}{\vert H \vert ( \vert H \vert - 1 )} {\sum }_{i , {i}^{′} ∈ H} {‖ {p}_{i} - {p}_{{i}^{′}} ‖}_{TV} ,$$

where ∥p−q∥_{TV}=Σ_{d∈}W½|p(d)−q(d)|. By definition δ_{H}∈[0, 1], with δ_{H}=1 corresponding to a household in which no two users both rated a movie on the same day of the week (possibly in different weeks).

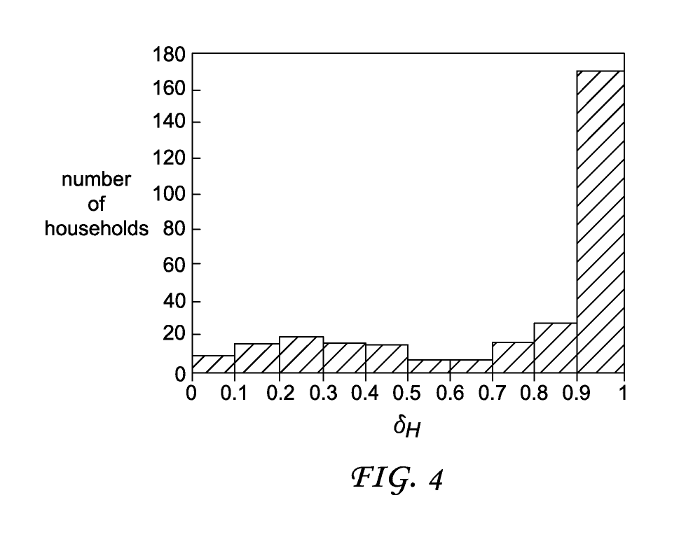

FIG. 4 shows the empirical probability distribution of δ_{H} across different households H. The distribution of δ_{H} is well concentrated around 1, with more than 70% having δ_{H}>0.8. This is a quantitative measure of the phenomenon suggested by FIG. 3.

### Viewer Prediction Based on Time-Stamps

In this section, three simple predictors of the household member who watches a movie. are presented. The third predictor exploits the fact that the day of the week can serve as a very good indicator of which member is watching a movie, as suggested by FIG. 4.

The predictors maximize the likelihood a given member rated a movie; each predictor assumes a different model of how movie ratings take place.

The simplest model assumes that each time a movie is watched in household H, the user i∈H is chosen at random with distribution q_{H}(i) independent of everything else. This probability can be estimated from the training set as follows for household H (we suppress the household subscript since this is fixed to H throughout):

$$q ( i ) = \frac{\vert \{ ( {i}^{′} , j , {M}_{{i}^{′} j} , {t}_{{i}^{′} j} ) ∈ Train : {i}^{′} = i \} \vert}{\vert \{ {i}^{′} , j , {M}_{{i}^{′} j} , {t}_{{i}^{′} j} ) ∈ Train : {i}^{′} = H \} \vert} .$$

Given a time t at which a movie is viewed, recall that b(t)∈{1, . . . , T} denotes the time bin. As in the previous section, we use T=12 here (one bin per month). In the second model, the probability that the rating was given by user i depends only on the time bin b(t) in which it occurred, and is independent from everything else, conditional on b(t):

$$q ( i \vert b ( t ) ) = \frac{\vert \{ ( {i}^{′} , j , {M}_{{i}^{′} j} , {t}_{{i}^{′} j} ) ∈ Train \text{:} {i}^{′} = i ⋀ b ( {t}_{{i}^{′} j} ) = b ( t ) \} \vert}{\vert \{ {i}^{′} , j , {M}_{{i}^{′} j} , {t}_{{i}^{′} j} ) ∈ Train \text{:} {i}^{′} ∈ H ⋀ b ( {t}_{{i}^{′} j} ) = b ( t ) \} \vert}$$

Finally, let d(t)∈W={Sun, Mon, . . . Sat} be the day of the week at which the viewing occurs. Our third model assumes that the user who rated the movie is independent from everything else, conditional on the day of the week:

$$q ( i \vert d ( t ) ) = \frac{\vert \{ ( {i}^{′} , j , {M}_{{i}^{′} j} , {t}_{{i}^{′} j} ) ∈ Train \text{:} {i}^{′} = i ⋀ d ( {t}_{{i}^{′} j} ) = d ( t ) \} \vert}{\vert \{ {i}^{′} , j , {M}_{{i}^{′} j} , {t}_{{i}^{′} j} ) ∈ Train \text{:} {i}^{′} ∈ H ⋀ d ( {t}_{{i}^{′} j} ) = d ( t ) \} \vert} .$$

Given a tuple (H,j,M_{Hj},t_{Hj})∈Test, consider the following three simple classification algorithms:

$${arg max}_{i ∈ H} q ( i ) , {arg max }_{i ∈ H} q ( i \vert b ( {t}_{H} ) ) , {arg max}_{i ∈ H} q ( i \vert d ( {t}_{Hj} ) ) .$$

Note that the second and third algorithms make use of the time at which a viewing event takes place. None of the three uses the actual rating M_{Hj} given by the user. Below an algorithm is presented that does use the rating in the next section.

### Generative Model

In order to account for ratings given by the users in our prediction, a generative model for how users rate movies is introduced. This model assumes that the rating given by a user is normally distributed around the prediction made by the low rank approximation algorithm described above. In particular, recall that the predicted rating of a user i∈[m] viewing movie j∈[n] at time t is given by

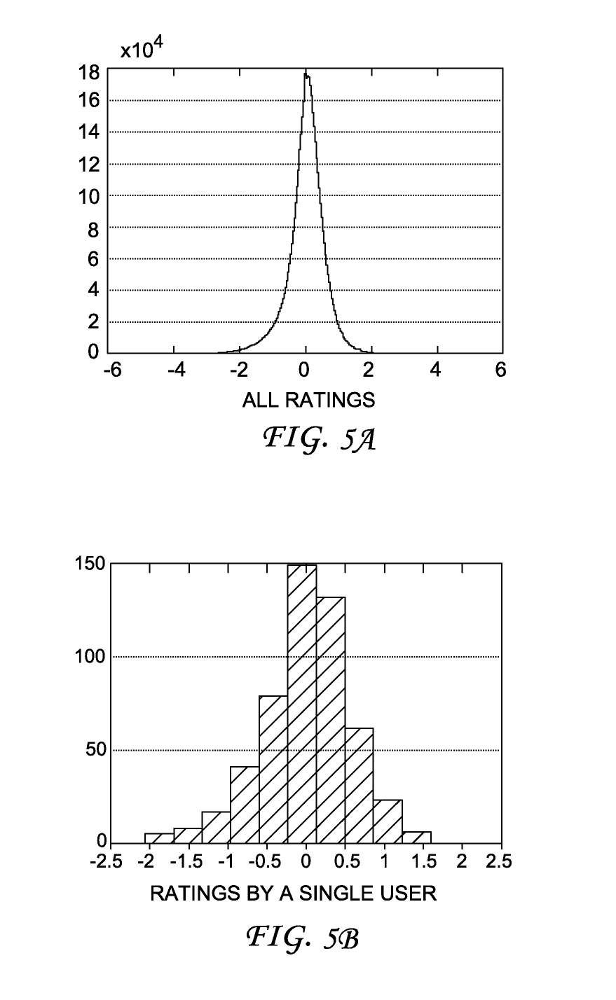

\hat{M}ᵢⱼ(b(t))=zᵢ(b(t))+ [symbol] uᵢ(b(t)),vᵢ(b(t)) [symbol] (10)

where uᵢ, vⱼ∈ [symbol] are the vectors associated with i and j, respectively, and zᵢ is the centering component. This prediction depends on the time-stamp t only through the bin b(t). FIG. 5 (a) shows the distribution of the residual error

Mᵢⱼ−\hat{M}_{i,j}(b(tᵢⱼ))

across all user/movie pairs (i j) in the training set. The distribution seems to be well approximated by a normal distribution, FIG. 5 (b) shows the distribution of residuals for a single user (user with ID 56094 in the training set). This still roughly agrees with a Gaussian distribution, although not as closely as for the overall distribution.

This motivates modeling the rating given by a user i for a movie j at time t by a normal distribution N(\hat{M}ᵢⱼ(b(t)),σ), where \hat{M}ᵢⱼ(b(t)) is given by and σ² is the variance of the residual error, as estimated from the training set. More specifically, given that a user from household H views a movie j at time t_{Hj}, it is possible to model the joint probability that (α) user i∈H is the rater and (b) i gives a rating M as follows:

$$ℙ ( i , M ) = \frac{1}{S } {e}^{- \frac{{( M - {\hat{M}}_{ij} ( b ( {t}_{Hj} ) ) )}^{2}}{2 {σ}^{2}}} q ( i ) . \qquad ( 11 )$$

where S=\sqrt{2πσ²}. Alternative models are obtained if this is condition edon the bin or the day of
the rating, as discussed in the previous section:

$$\begin{matrix}ℙ ( i , M \vert b ( {t}_{Hj} ) ) = \frac{1}{S } {e}^{- \frac{{( M - {\hat{M}}_{ij} ( b ( {t}_{Hj} ) ) )}^{2}}{2 {σ}^{2}}} q ( i \vert b ( {t}_{Hj} ) ) , & ( 12 ) \\ ℙ ( i , M \vert d ( {t}_{Hj} ) ) = \frac{1}{S } {e}^{- \frac{{( M - {\hat{M}}_{ij} ( b ( {t}_{Hj} ) ) )}^{2}}{2 {σ}^{2}}} q ( i \vert d ( {t}_{Hj} ) ) . & ( 13 )\end{matrix}$$

Given a tuple (H,j,M_{Hj},t_{Hj})∈Test, the posterior probability that i∈H is the movie viewer under the above three generative models can be written as:

$$P ( i \vert {M}_{Hj} , \cdot ) = P ( i , {M}_{Hj} \vert \cdot ) / {\sum }_{{i}^{′} ∈ H} ℙ ( {i}^{′} , {M}_{Hj} \vert \cdot ) .$$

As a result, the following rule can be used as a classifier of tuples (H,j,M_{Hj},t_{Hj})∈Test:

$${arg max}_{i ∈ H} ℙ ( i , {M}_{Hj} \vert \cdot )$$

where [symbol] (i,M_{Hj}|·) is given for each of the three generative models and is known.

Empirical Results

The classification algorithms were evaluated by cross validation on the training and test sets, as described above. For classifiers based on the generative models, the low-rank model was selected to be the same (wherein T=12, r=10, λ=1, ξᵤ=10, ξᵥ=ξ_{z}=40).

TABLE 2
Misclassification rates P for algorithms, with standard
deviations derived over five iterations of cross validation.

| | σ = ∞ | σ = σₐₗₗ | σ = σᵢ |
|---|---|---|---|
| q(i) | 0.3916 ± 0.0081 | 0.3264 ± 0.0102 | 0.3066 ± 0.0112 |
| q(i\|b(t_{Hj})) | 0.3626 ± 0.0080 | 0.2956 ± 0.0065 | 0.2777 ± 0.0084 |
| q(i\|d(t_{Hj})) | 0.1129 ± 0.0066 | 0.1008 ± 0.0066 | 0.0966 ± 0.0072 |

The results are summarized in Table 2 in terms of the misclassification rate. The first column of the table (σ=∞) corresponds to the classifiers (not using the ratings). The second and third columns correspond to the other classifiers regarding the generative model. In the second column, the variance a used in the normal distribution is estimated by the empirical variance of the residual errors over all ratings in the training set. In the third column, a user-dependent variance σᵢ for each i∈[m] was used. This is estimated by the variance of the residual errors of ratings given by i. Finally, each row corresponds to a different assumption on the posterior probability q, with the second and third rows corresponding to the use of bin and weekday information, respectively (c.f. Eq. 12 and 13).

It is observed that, in all cases, using the bin information helps compared to using the unconditional probability q(i), but only marginally so. The largest improvement comes from conditioning on the day of the week. This decreases the misclassification rate by a factor between 3 and 4 compared to using the unconditional probability q(i). Incorporating the generative model also decreases the misclassification rate: classification using the generative model conditioned on the day of the week, along with individual variances σᵢ, outperforms all other methods, with P≈0.0966.

As mentioned above, these are misclassification rates estimated through five-fold cross-validation. These are pointed out in detail because they provide a metric that is statistically more robust. When using the original split in train and test sets provided in the challenge, (for the third column, σ=σᵢ) respectively P≈0.3028 (model q(i)), 0.2765 (model q(i|b(t_{Hj}))), 0.0950 (model q(i|d(t_{Hj}))) is achieved. For this same split, and for the model q(i|d(t_{Hj})), the values for P₂, P₃ and P₄ are 0.0940, 0.1051 and 0.1315 respectively.

Finally, these results remain excellent if evaluated in terms of ROC curves, and Area Under the Curve (AUC). AUC is computed as follows. Consider a household H, a user i, and the corresponding probabilities pⱼ= [symbol] (i|M_{Hj},·). Let a be the number of unordered pairs (j,f) such that pⱼ>p_{j′} and j′ was indeed rated by i, while j was not. Let b be the product between the number of entries in the test set that were rated by user i and the number of entries that were not. Define AUC_{i,H}=1−a/b. AUC_{i,H} is the area under the ROC curve for user i versus any other user in household H. Estimate AUC by averaging the above quantity over i and H in the test set for which b≠0. Using the original split in test and train set provided with the challenge dataset, obtain (again for the third column, σ=σᵢ) respectively AUC≈0.6170 (model q(i)), 0.6619 (model q(i|b(t_{Hj}))), 0.8947 (model q(i|d(t_{Hj}))).

Referring back again to FIG. 7, at step 90 temporal patterns over a time frame are observed. At step 100, the time frame is divided into a plurality of sub-time frames and it is determined at step 110 whether the sub-time frames themselves exhibit temporal patterns. If not, then the method would return to step 90 to examiner other datasets or time frames to discover temporal patterns. If so, then at step 120 empirical probability distributions of rating events over the sub-time frames are obtained. It is then desired at step 130 to predict the user content acquisition behavior based on the temporal patterns and the empirical distributions so that at step 140 the user profiles can be obtained. The method then stops at 150.

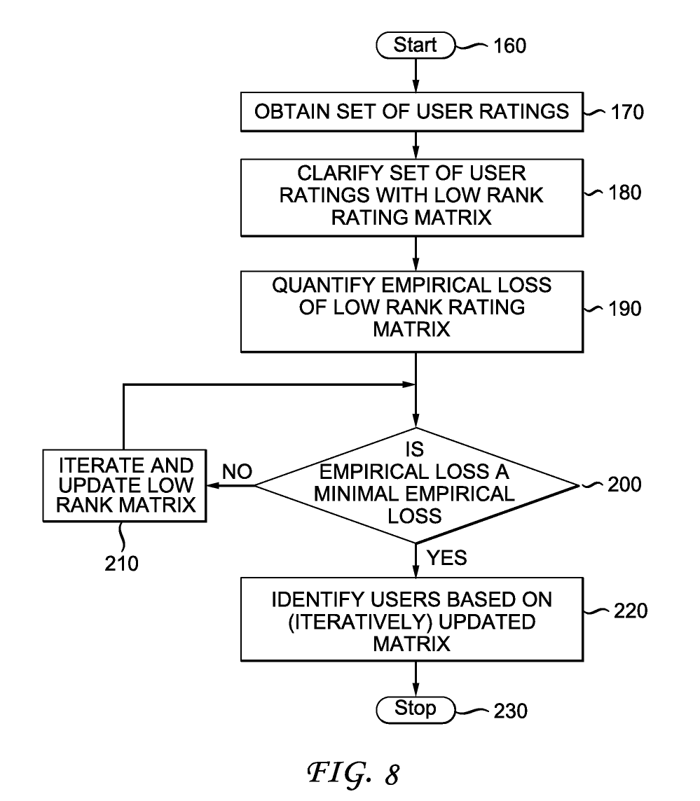

FIG. 8 depicts a further preferred embodiment of a method of indentifying users of content provided in accordance with the present invention. The method starts at step 160, and at step 170 a set of user ratings are obtained. At step 180 the user ratings are classified according to a low rank rating matrix. At step 190, an empirical loss created by the low rank rating matrix is quantified. It is then determined at step 200 if the quantified empirical loss is a minimal empirical loss. If the quantified empirical loss is not minimal, then at step 210 an iteration of the low loss rating matrix is undertaken and the low rank rating matrix is updated. The method then returns to step 200 for further quantification of the empirical loss to determine if the empirical loss is now minimal.

If however the quantified empirical loss is minimal, then at step 220 the users of the content are identified based on the low rank matrix, or based on the iteratively updated matrix as the case may be. The method then stops at step 230.

It will be appreciated that in any of the embodiments of FIG. 6, 7 or 8, a unified approach could be taken wherein further contextual information can be added. The unified framework is based on binary classification to exploit latent space information as well as temporal information, and additional contextual information. The binary classification module is regularized logistic regression, but could be replaced by a number of equivalent methods. By using composite feature vectors including several types of information, P≈0.0406 is achieved. For example, in addition to the time stamp of the ratings, the actual time of entry by the user of the rating can be utilized to provide further contextual information.

Performance Metrics

Of the 290 households, the vast majority, namely 272, is formed by 2 users, while 14 include 3 users, and only 4 are formed by 4 users. As a consequence of this, a purely random inference algorithm achieves an average misclassification rate over all households that is slightly above 50% (indeed, approximately 0.511). The same random inference algorithm achieves an average misclassification rate of 50% over households of size 2, of 66% over households of size 3 and 75% over households of size 4. This performance provides a baseline for the algorithms developed in this paper.

As a performance metric standard ROC variables are used (true positive rate and one minus false positive rate). More precisely, given a household with two users i=1 and i=2, we let T1 and 72 be the total number of entries in Test, that correspond to user 1 and user 2 respectively while, TP1(Alg), TP2(Alg) are the number of those entries assigned by algorithm Alg to 1 and 2. Then the corresponding true positive rates are

$$TRP 1 ( Alg ) = \frac{TP 1 ( Alg )}{T 1} , TRP 2 ( Alg ) = \frac{TP 2 ( Alg )}{T 2} . \qquad ( 4 )$$

Notice that TPR2(Alg) is equal to one minus the false positive rate in predicting 1, so these are the usual ROC variables. This definition is generalized in the obvious way in the case of 3- and 4-user households.

The total misclassification rate per household H is defined as follows in terms of the above quantities (always considering 2-user households but easily generalized)

$$P ( Alg , H ) ≡ 1 - \frac{TP 1 ( Alg ) + TP 2 ( Alg )}{T 1 + T 2} , \qquad ( 5 )$$

Defining P to be the average of P(Alg,H) over all households, compute the average of P(Alg,H) over households of size 2 only, of size 3 only and size 4 only. These values are denoted by P₂, P₃ and P₄ respectively.

In order to obtain a 2-dimensional ROC curve, the true positive rate for—say—user 1 against the true positive rate for the union of users 2 and 3 are plotted.

The described and claimed methods confirm the usefulness of low-rank approximation and the importance of accounting for temporal evolution. At the same time, the present dataset provides striking evidence of these two points. Furthermore, the precise form of temporal patterns and their extraction in the form of weekly and daily habits is novel and extremely powerful.

The importance of the time of day as context for recommendations has been noted in the past, e.g., in recommending music tracks. Another striking advantage of the disclosed methods is that, in the challenge dataset, users within a given household tend to view and rate movies at different times of the day and different days of the week. Thus, time is an important factor not only in recommendations but also in user identification. These results have not heretofore been achieved in the art.

There have thus been described certain preferred embodiments or methods and apparatus indentifying users of content provided in accordance with the present invention. While preferred embodiments have been described and disclosed, modifications are within the true spirit and scope of the invention. The appended claims are intended to cover all such modifications.

1. A method of indentifying users of content, comprising the steps of:
identifying contextual information of a group of users;
gathering user access data of the users on the basis of the contextual information of the group of users;
analyzing temporal information of the user access data; and
identifying particular users in the group of users on the basis of the analyzed temporal information and the contextual information.

2. The method of claim 1, wherein the contextual information is information concerning a social structure to which the users belong.

3. The method of claim 2, wherein the social structure comprises a household.

4. The method of claim 3, wherein the temporal information further comprises a time stamp.

5. The method of claim 3, further comprising the step of analyzing user ratings of the content.

6. A method of identifying users of content, comprising the steps of:
observing temporal patterns of viewing of a group of users over a time frame;
quantifying the observations of the temporal pattern to obtain an empirical probability distribution of rating events associated with the users over different sub-time frames within the time frame; and
predicting each user's content use behavior based on the quantified temporal observations to obtain a predicted use profile for the users.

7. A method of identifying users of content, comprising the steps of:
classifying a set of user ratings of content by approximating a matrix of ratings by a low rank matrix;
minimizing regularized empirical loss of the matrix of ratings;
iteratively updating the matrix of ratings and updating the matrix after empirical losses are minimized; and
identifying users based the iteratively updated matrix.

8. The method of claim 7, further comprising the step of by applying temporal information to the matrix of ratings.

9. The method of claim 8, wherein the temporal information comprises a time stamp.

10. The method of claim 9, further comprising the step of attributing a rating to a user for which a predicted rating is closest to an actual rating.

11. A method of identifying users of content, comprising the steps of:
identifying contextual information of a group of users;
gathering user access data of the users on the basis of the contextual information of the group of users;
analyzing temporal information of the user access data, wherein the contextual information comprises time-stamp information and information related to when a user rating of the content is entered; and
identifying particular users in the group of users on the basis of the analyzed temporal information and the contextual information.

12. The method of claim 11, wherein the contextual information is information concerning a social structure to which the users belong.

13. The method of claim 12, wherein the social structure comprises a household.

14. The method of claim 13, further comprising the step of analyzing user ratings of the content.

15. Apparatus for identifying users of content, comprising:
a processor for identifying contextual information of a group of users, gathering user access data of the users on the basis of the contextual information of the group of users, analyzing temporal information of the user access data, and identifying particular users in the group of users on the basis of the analyzed temporal information and the contextual information.

16. The apparatus of claim 15, wherein the contextual information is information concerning a social structure to which the users belong.

17. The apparatus of claim 16, wherein the social structure comprises a household.

18. The apparatus of claim 16, wherein the temporal information further comprises a time stamp.

19. The apparatus of claim 18, further comprising the step of analyzing user ratings of the content.
